(19) United States
(12) Patent Application Publication
(10) Pub. No.: US 2005/0238058 A1
(43) Pub. Date: Oct. 27, 2005

(54) Synchronization of upstream and downstream data transfer in wireless mesh topologies

(76) Inventors: Kenneth Leigh Peirce JR., Folsom, CA (US); Paul F. Dietrich, Seattle, WA (US)

Correspondence Address: MARK J. SPOLYAR, 38 FOUNTAIN ST., SAN FRANCISCO, CA, 94114, US

(21) Appl. No.: 10/831,908

(22) Filed: Apr. 26, 2004

(51) Int. Cl. H04J 3/06

(52) U.S. Cl. 370/503; 370/345

(57) ABSTRACT

Methods, apparatuses and systems directed to synchronizing upstream and downstream transmissions across routing nodes in a wireless mesh network. The present invention, in one implementation, reduces radio interference between routing nodes in a wireless mesh network. In one implementation, the present invention, also allows for the use of a single radio dedicated to wireless backbone transmissions thereby reducing the cost of routing nodes. In one implementation, at least some of the routing nodes in the wireless mesh network include a second radio and associated wireless communication functionality to provide wireless access to mobile stations.

### FIELD OF THE INVENTION

The present invention relates to wireless mesh communication networks and, more particularly, to a synchronization mechanism that facilitates data transfer between routing nodes in a wireless mesh network.

### BACKGROUND OF THE INVENTION

Wireless mesh communication networks typically consist of a plurality of wireless routing nodes that operate in an ad-hoc, peer to peer fashion to establish communication paths to one another for the purposes of providing access to a network to wireless clients or mobile stations. Many wireless mesh networks are hierarchical in nature with the routing nodes that bridge wireless traffic onto a wired network at the top of the hierarchy. The wireless mesh routing nodes can be one- or two-radio systems including omni-directional and/or directional antennas. In one-radio systems, the radio unit is used for purposes of acting as an access point to its clients, as well as acting as a backhaul to a parent routing node. In two-radio systems, one radio unit provides access point service to wireless clients as well as child routing nodes, while the other radio unit is used as a backhaul to a parent routing node. In certain wireless mesh networks, the backhaul radio operates in station mode, appearing as a wireless client to the parent routing node. The access point radio unit operates in access point mode, providing wireless connections to mobile stations, as well as child routing nodes operating in station mode through their respective backhaul radios.

As the number of routing nodes in a wireless mesh network increases, certain problems are created due to the fact that the routing nodes essentially share the transmission medium. To avoid radio interference among the routing nodes, each routing node in a wireless mesh network generally employs a packet collision avoidance mechanism as part of the wireless communications protocol, such as the 802.11 protocol. Accordingly, a typical way of initiating communication between routing nodes begins with the transmission of a “Request-to-send” (RTS) packet by an initiating routing node. This packet is typically received by all routing nodes within the transmission range of, and operating on the same channel, as the initiating routing node. The RTS packet notifies these routing nodes that the initiating routing node intends to transmit a flow of packets to a specified target routing node. After receiving an RTS packet, the target routing node responds by transmitting a “Clear-to-send” (CTS) packet that notifies the initiating routing node that the target routing node is ready to receive the data stream. The CTS packet also serves to notify other routing nodes within range that the transmission medium has been reserved such that they refrain from transmissions that might interfere with the transmission between the initiating and target routing nodes. Accordingly, since other routing nodes within range of the initiating and target routing nodes are forced to remain idle during transmission of the data stream, system throughput can be drastically impaired as the number of routing nodes and clients increase.

To address these problems, mesh network routing nodes can employ channel assignment schemes and mechanisms to eliminate interference between adjacent routing nodes. The limited number of non-overlapping operating channels in a given band, however, does present certain limitations for channel re-use when the number and/or density of routing nodes increases. Directional antennas have also been deployed to reduce or control interference across routing nodes. Without some coordination mechanism, however, interference between routing nodes remains a significant factor. In light of the foregoing, a need in the art exists for coordinating wireless transmissions across routing nodes in a wireless mesh network. Embodiments of the present invention substantially fulfill this need.

### SUMMARY OF THE INVENTION

The present invention provides methods, apparatuses and systems directed to synchronizing upstream and downstream transmissions across routing nodes in a wireless mesh network. The present invention, in one implementation, reduces radio interference between routing nodes in a wireless mesh network. In one implementation, the present invention, also allows for the use of a single radio dedicated to wireless backbone transmissions thereby reducing the cost of routing nodes. In one implementation, at least some of the routing nodes in the wireless mesh network include a second radio and associated wireless communication functionality to provide wireless access to mobile stations. The present invention can be deployed in a variety of hierarchical or linear network topologies.

### DESCRIPTION OF THE DRAWINGS

FIG. 1 is a functional block diagram illustrates a hierarchical wireless mesh network according to an implementation of the present invention.

FIG. 2 is a schematic diagram illustrating the logical configuration, according to one implementation of the present invention, of a wireless routing node.

FIG. 3 is a flow chart diagram setting for a method, according to one implementation of the present invention, directed to synchronizing upstream and downstream transmissions across routing nodes in a wireless mesh network.

FIG. 4 is a block diagram illustrating the operation of an embodiment of the present invention.

FIG. 5 illustrates the layout of a wireless frame, according to an implementation of the present invention.

FIG. 6 provides the layout of a message routing header according to one implementation of the present invention.

FIG. 7 is a flow chart diagram setting for a method, according to another implementation of the present invention, directed to synchronizing upstream and downstream transmissions across routing nodes in a wireless mesh network.

FIG. 8 is a flow chart diagram setting for a method, according to another implementation of the present invention, directed to synchronizing upstream and downstream transmissions across routing nodes in a wireless mesh network.

### DESCRIPTION OF PREFERRED EMBODIMENT(S)

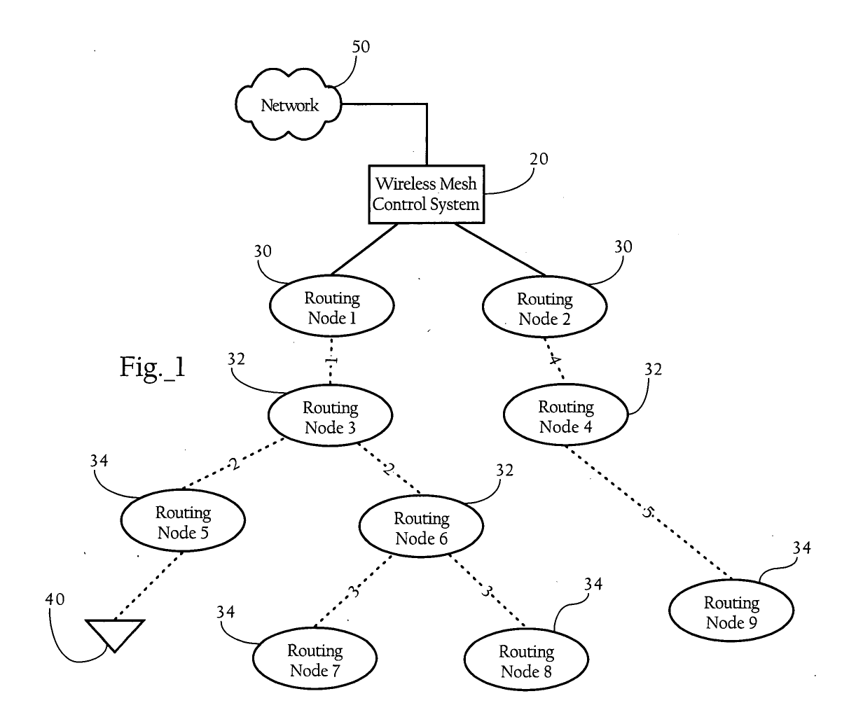

FIG. 1 illustrates a wireless mesh network according to an implementation of the present invention. In one implementation, the wireless mesh network includes a wireless mesh control system 20, and a plurality of routing nodes. In one implementation, a hierarchical architectural overlay is imposed on the mesh network of routing nodes to create a downstream direction towards leaf routing nodes 34, and an upstream direction toward the root routing nodes 30. For example, in the hierarchical mesh network illustrated in FIG. 1, first hop routing node 1 30 is the parent of intermediary routing node 3 32. In addition, intermediate routing node 3 32 is the parent to leaf routing node 5 34, and intermediate routing node 6 32. In one implementation, this hierarchical relationship is used in routing packets between wireless clients 40, or between wireless clients 40 and network 50. As discussed in more detail below, this hierarchical architecture is also used in synchronizing upstream and downstream transmissions between routing nodes. In the wireless mesh network illustrated in FIG. 1, the routing nodes are arranged in two hierarchical tree structures-one root node is routing node 1, while the other root node is routing node 2. Of course, a variety of hierarchical configurations are possible including fewer or greater number of hierarchical tree structures. In addition, the upstream/downstream synchronization functionality according to the present invention can be applied to a linear, or other serial, arrangement of routing nodes.

The routing nodes in the mesh network, in one implementation, generally include one radio and associated wireless communication functionality to communicate with other routing nodes to thereby implement the wireless backbone, as discussed more fully below. All or a subset of the routing nodes, in one implementation, also include an additional radio and other wireless communication functionality to establish and maintain wireless connections with mobile stations, such as wireless client 40.

FIG. 1 also illustrates the channel assignment between routing nodes according to one possible implementation of the present invention. In one implementation, the routing nodes for a given tree and a given hop are set to the same channel. Additionally, for a given routing node, the operating channel for upstream data transfer, in one implementation, is different than the operating channel used for downstream data transfer. For example, wireless transmissions between routing node 1 and routing node 3 occur on channel 1, while routing node 3 communicates with routing node 5 and routing node 6 on channel 2. In one implementation, the channel assignments between routing nodes is statically configured. In other implementations, operating channels can be dynamically assigned.

As discussed more fully below, each routing node in the mesh network, in one implementation, is operative to transmit and receive packets from other routing nodes according to a mesh routing hierarchy. Each mesh routing node, in one implementation, is further operative to establish and maintain wireless connections to one or more wireless client devices 40. Mesh network control system 20, in one implementation, is operative monitor to which routing node each wireless client is associated and route packets destined for the wireless clients accordingly.

A. Synchronization of Upstream and Downstream Transmission

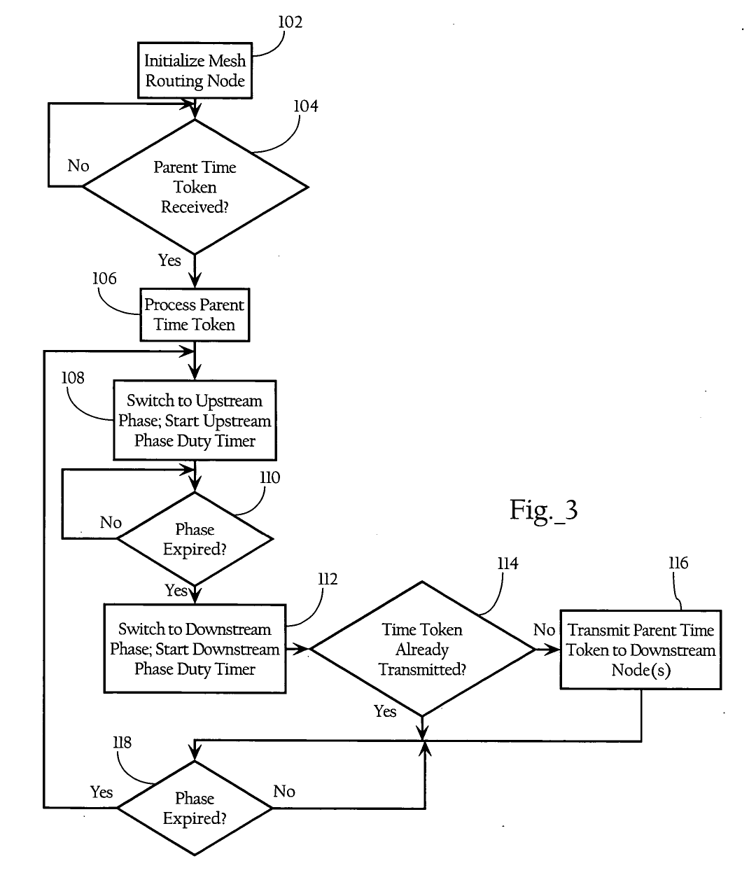

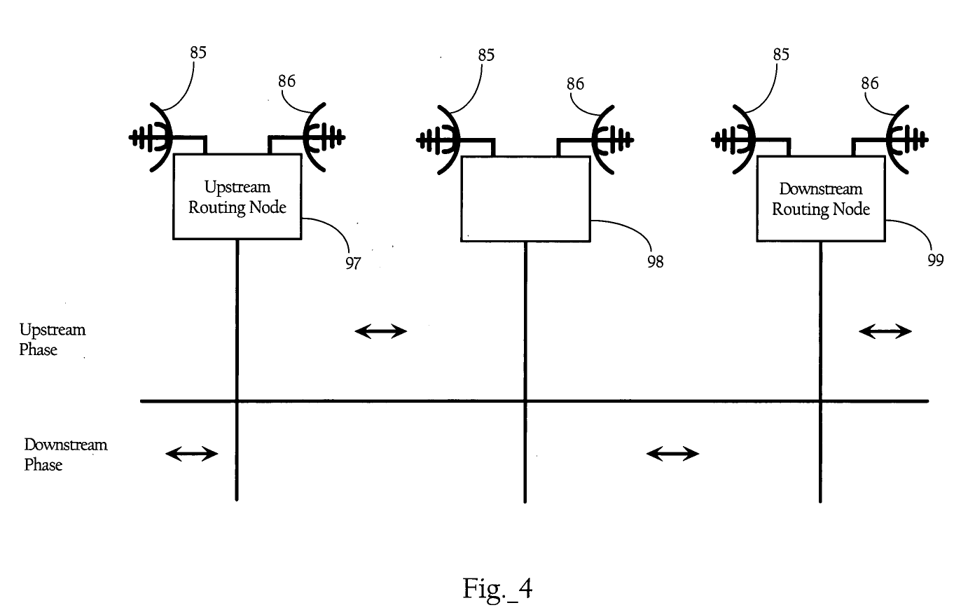

FIG. 3 illustrates a method, according to an implementation of the present invention, directed to synchronizing upstream and downstream wireless frame transfer between wireless routing nodes in the hierarchical mesh network. In the implementation described, the intermediate routing nodes 32 in the mesh network continuously switch between an upstream and a downstream phase in a synchronized manner. The root routing nodes 30 and leaf routing nodes 34, however, can operate in one of the upstream or downstream phases, as appropriate, since these routing nodes do not have a downstream/upstream routing node with which to exchange wireless packets. FIG. 4 illustrates the synchronization of upstream and downstream data transfer between a given routing node and its parent and child routing nodes.

As FIG. 3 illustrates, at initialization or start up (102), a routing node switches to the upstream mode and listens for a parent synchronization token (104) from its parent routing node. When a parent synchronization token is received, the routing node processes the parent synchronization token (106). The routing node then switches to the upstream phase (if not done so already), and starts an upstream phase duty timer (108). In one implementation, the routing node, upon receipt of the initial synchronization token, installs a duty timer interrupt service routine. As FIGS. 3 and 4 show, the routing node 98 operates in the upstream phase to transmit data to, and receive data from, the upstream (parent) routing node 97. When the upstream phase duty time expires (110), the routing node 98 switches to the downstream phase to transmit data to, and receive data from, the downstream (child) routing node 99 and starts the downstream phase duty timer (112). As FIG. 1 illustrates, however, routing node 98 may communicate with more than one child routing node 99 during the downstream phase. In one implementation, routing node 98 also transmits a parent synchronization token to any downstream routing nodes 99 (116), if it has not been transmitted previously (114). The downstream routing node 99 receives the parent synchronization token and processes it as described herein. After the downstream phase expires (118), routing node 98 again switches to the upstream phase 108.

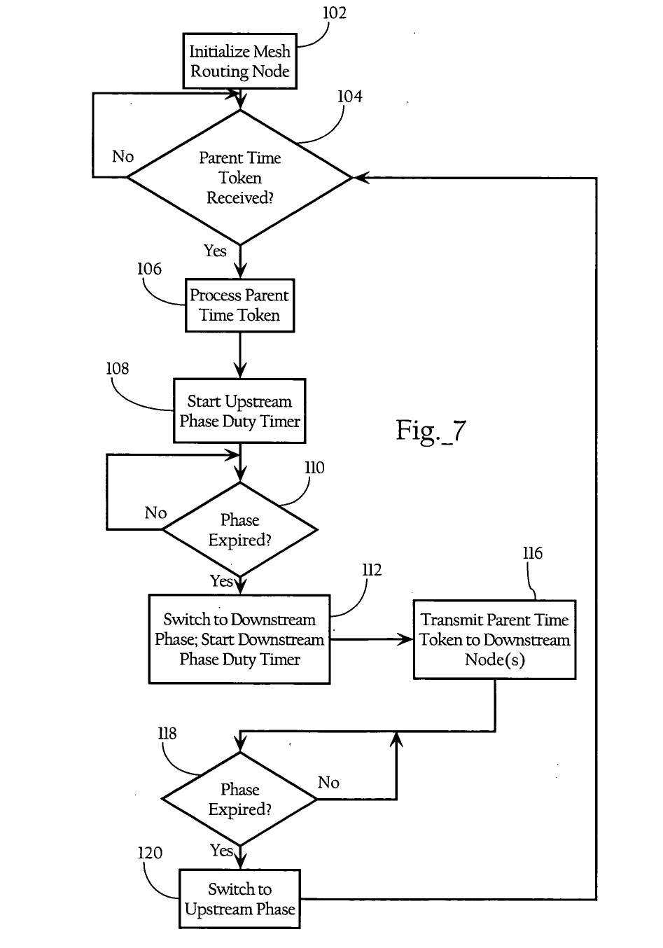

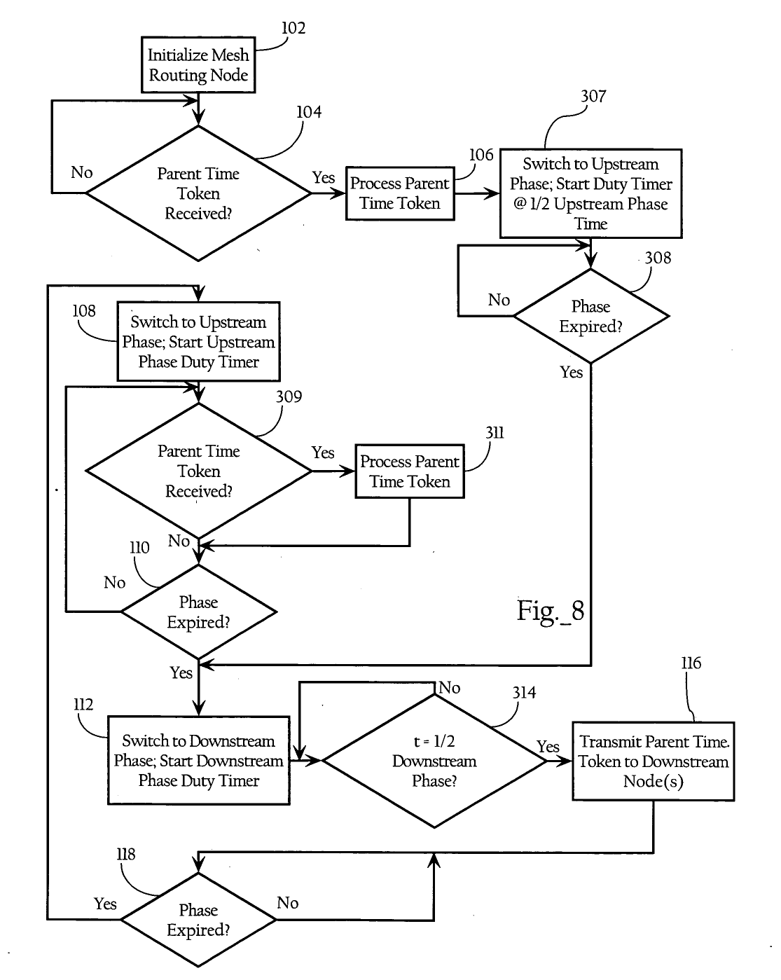

Other variations are possible. As FIG. 7 illustrates, for example, a parent synchronization token can be transmitted to downstream routing nodes at every cycle to compensate for any timing drift among the routing nodes in the mesh network. As FIG. 7 illustrates, after expiration of the downstream phase (118), routing node 98 switches to the upstream phase (120) and waits for receipt of a parent synchronization token (104), before starting the upstream phase duty timer (108). In another implementation, routing node 98 can be configured to listen for a parent synchronization token every N cycles (where N is a configurable parameter), before starting the upstream duty timer. In addition, as FIG. 8 illustrates, parent time tokens can be transmitted in the middle of the downstream transmission phase. More specifically, as FIG. 8 shows, after initialization of the routing node 98 (102) and receipt of the first parent time token, routing node 98 switches to the upstream transmission phase, setting the duty cycle time to the midpoint of the upstream transmission phase (307). After the upstream phase has expires (in this case 1/2 of the normal upstream phase) (308), routing node 98 switches the downstream phase (112). As FIG. 8 further illustrates, in one implementation, routing node 98, like its parent routing node, is configured to transmit a parent time token (116) in the middle of the downstream transmission phase (314). Conversely, in the upstream transmission phase, routing node 98 can be configured to listen for a parent time token (309) and process the parent time token (311) when it is received. In one implementation, routing node 98 processes the parent time token be calibrating its duty cycle time, assuming that receipt of the parent time token marks the mid-point of the upstream phase. The implementation described in FIG. 8 prevents clock drift among the routing nodes from causing a situation where a child routing node does not switch to the upstream phase in time to receive a parent time token from a parent routing node. In other implementations, transmission of the parent time token can occur at other points during the downstream transmission phase with corresponding adjustments to the calculations described above.

As FIG. 3 illustrates, routing node 98 repeatedly switches between the upstream phase and the downstream phase depending on a configured duty cycle (e.g., 50% upstream, 50% downstream) and repetition interval. In one implementation, the duty cycle and repetition interval is uniform across all routing nodes. Furthermore, as FIGS. 3 and 4 illustrate, the parent synchronization token propagates down the routing node hierarchy and thereby synchronizes the upstream and downstream phases of parent and child routing nodes. As discussed above, FIG. 4 illustrates the synchronization of the upstream and downstream phase relative to routing node 98. In the upstream phase, routing node 98 exchanges wireless frames with upstream routing node 97. Assuming that downstream routing node 98 is also an intermediate routing node, it also exchanges data with a child routing node. In the downstream phase (relative to routing node 98), routing node 98 exchanges wireless frames with downstream routing node 99, while upstream routing node 97 exchanges wireless frames with its parent routing node (if any).

Wireless communication between routing nodes, during the upstream and downstream phases, can be accomplished in a variety of manners. For example, routing nodes, in one implementation, implement the 802.11 wireless communications protocol. Furthermore, the wireless connection between routing nodes can operate in an access point mode or an ad hoc mode. In the upstream phase, routing node 98, for instance, can operate in station mode as a wireless client to upstream routing node 97. In the downstream phase, routing node 98 can operate in an access point mode to communicate with any child routing nodes 99. Of course, other wireless communications protocols can also be used.

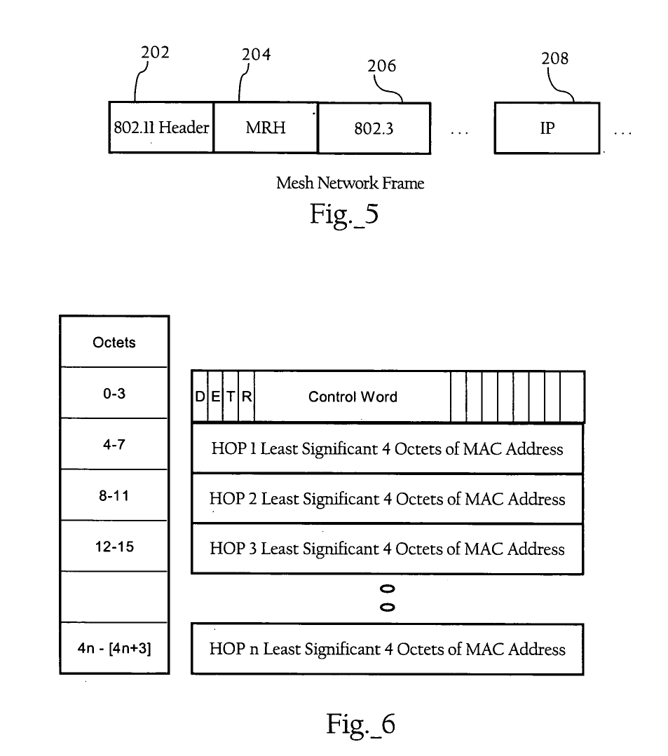

In one implementation, the parent synchronization token is a single wireless frame including a Message Routing Header (MRH) (see FIGS. 5 and 6, and description below) where the flag “T” is set to indicate that the frame is a synchronization token. In one implementation, a parent routing node can individually transmit synchronization tokens to child routing nodes, or multicast the synchronization tokens to its child routing nodes. Still further, although in the embodiment described above synchronization tokens propagate downstream from root to leaf node, synchronization tokens can be initiated and propagate in the reverse direction from leaf to root node. Such an implementation requires the routing nodes to listen for tokens in the downstream direction upon initialization or startup.

B. Mesh Routing

In one implementation, mesh network control system 20, as well as each routing node includes functionality supporting mesh network routing operations. In one implementation, the uplink and downlink routing configuration for the routing node hierarchy is statically configured at each routing node. In another implementation, however, uplink and downlink routing information is dynamically configured according to a route discovery process detailed below.

Mesh network control system 20, in one implementation, is configured with all routes that define the hierarchical mesh network configuration. Mesh network control system 20, in one implementation, composes and transmits, for each hierarchical tree, route discovery packets, including routing information, to the leaf routing nodes 34 on each branch of a given tree. The routing nodes in the path to the leaf routing nodes 34 learn the identity of their respective parent and child routing nodes as the route discovery packet traverses the mesh network. For example, in one implementation, a route discovery packet includes a Message Routing Header 204 including the route to a leaf routing node 34. Upon receipt of a route discovery packet, routing node 1 sends it to the next hop identified in the message routing header. As these route discovery packets traverse the hierarchy of routing nodes to the leaf routing nodes 34, the routing nodes in the path record the information in the Message Routing Header. FIG. 5 illustrates some of the headers in a wireless frame transmitted between routing nodes. FIG. 6 illustrates a Message Routing Header according to one implementation of the present invention. As FIG. 5 illustrates, the wireless frame, in one implementation, is a 802.11 frame including an 802.11 header 202 encapsulating a Mesh Routing Header (MRH) 204. Other headers can include 802.3 or other link layer headers for use by the last hop routing node, as discussed more fully below, and IP headers 208.

In this manner, the routing nodes in the mesh network learn the MAC addresses of their parent and child routing nodes, as well as the route and hopcount along the path from the root routing node 30 to the leaf routing node 34. The information in the MRH of the route discovery packet allows the routing nodes to properly route wireless frames in the uplink direction. Use of route discovery packets in this manner obviates the need to statically configure uplink and downlink MAC addresses at each routing node. In addition, mesh network control system 20 can dynamically reconfigure the routes in the hierarchical mesh network simply by composing MRHs that define the desired routes and transmit them in route discovery packets to the leaf routing nodes 34. In one implementation, the leaf routing node 34 simply discards the route discovery packet. In another implementation, when the route discovery packet reaches a leaf routing node 34, the leaf routing node 34 records the MRH information, clears the MRH, and transmits the route discovery packet uplink to mesh network control system 20. As the route discovery packet traverses the mesh network in the upstream direction, the routing nodes at each hop add their MAC address to the MRH and route the packet to an upstream routing node using a least cost or other routing algorithm. In this manner, the mesh network control system 20 can learn new routes and possibly apply them by sending route discovery packets in the downstream direction.

As discussed above, in one implementation, each packet sent or received at the mesh routing control system 20 to or from a routing node hierarchy is encapsulated with a Message Routing Header (MRH) that contains the path to the destination. FIG. 6 illustrates a Message Routing Header according to an implementation of the present invention. The “D” in the control word indicates whether the route is read from the top or bottom. In one implementation, uplink routing from a wireless client to network 50, for example, is static and based on the Message Routing Header information recorded by the routing node during processing of route discovery packets. In one implementation, a routing node receiving a wireless frame performs one of the following operations: 1) stripping the 802.11 header and Message Routing Header and passing the packet to the WLAN interface, if the final MAC hop identified in the MRH is the processing routing node; and 2) updating the destination MAC address in the 802.11 header 202 with the next hop MAC address in the MRH, and placing the packet in an appropriate upstream or downstream queue for subsequent transmission.

Mesh network control system 20, in one implementation, adds and strips off the Message Routing Header for all packets going to or coming from a hierarchical tree in the mesh network. Mesh network control system 20 is also operative to bridge wireless traffic from the mesh network onto network 50. In one implementation, the mesh network control system 20 includes a graphical user interface (GUI) to assist in mesh organization, statistics gathering and route monitoring. In addition, in order to select routes downlink for wireless frames destined for wireless clients 40, mesh network control system 20 is operative to monitor to which routing node each wireless client is associated. In one implementation, each routing node can be configured to transmit a notification, such as an SNMP trap, to mesh network control system 20 after a wireless client associates with access point functionality of the routing node. In another implementation, mesh network control system 20 can detect new wireless client MAC addresses in the data flows that traverse the mesh network control system 20. Further, in one implementation, all wireless client traffic emanating from a wireless client 40 is first transmitted uplink to mesh network control system 20, which may apply policies to the traffic, before the wireless traffic is transmitted back downlink to another wireless client. Lastly, mesh network control system 20 may include interfaces and associated functionality that facilitate management and operation of the WLAN access point functionality at the routing nodes.

Lastly, as one skilled in the art will recognize, the foregoing illustrates a subset of the possible hierarchical mesh routing configurations that can be used in connection with the present invention. The present invention does not limit the mesh routing protocols and technologies that can be used.

C. Mesh Routing Node Configuration

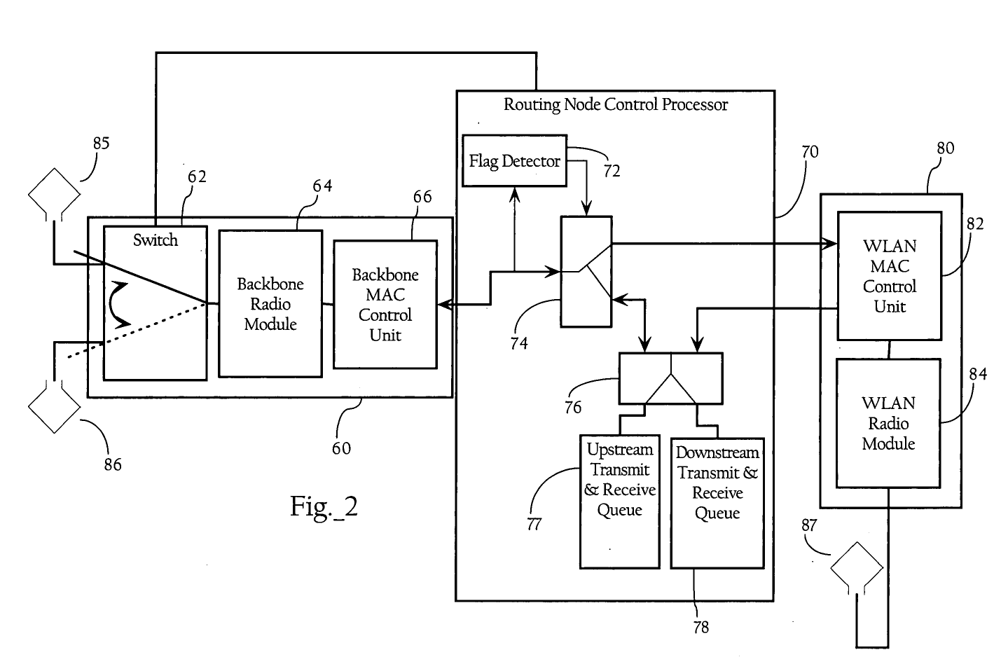

The following describes, for didactic purposes, the configuration of a mesh routing node according to one implementation of the present invention. Other routing node configurations are possible. FIG. 2 is a schematic diagram illustrating the essential logical and/or operating components according to one implementation of the present invention. As FIG. 2 illustrates, a mesh routing node generally comprises routing node control processor 70, wireless backbone interface unit 60, and WLAN interface unit 80. Wireless back bone interface unit 60 is operative to transfer wireless frames to upstream and downstream routing nodes under the control of routing node control processor 70, as discussed more fully below. WLAN interface unit 80 is operative to transfer wireless frames to and from wireless clients 40 under control of routing node control processor 70.

Wireless backbone interface unit 60, in one implementation, comprises upstream antenna 85, downstream antenna 86, switch 62, backbone radio module 64, and backbone MAC control unit 66. In other implementations using a single omni-directional antenna, switch 62 is not required. Backbone radio module 64 includes frequency-based modulation/demodulation functionality for, in the receive direction, demodulating radio frequency signals and providing digital data streams to backbone MAC control unit 66, and in the transmit direction, receiving digital data streams and providing frequency modulated signals corresponding to the digital data stream. In one embodiment, radio module 64 is an Orthogonal Frequency Division Multiplexed (OFDM) modulation/demodulation unit. Of course, other modulation and multiplexing technologies can be employed, such as Frequency Hopping Spread Spectrum (FHSS) or Direct Sequence Spread Spectrum (DSSS). Backbone MAC control unit 66 implements data link layer functionality, such as detecting individual frames in the digital data streams, error checking the frames, and the like. In one embodiment, backbone MAC control unit 66 implements the 802.11 wireless network protocol (where 802.11, as used herein, generically refers to the IEEE 802.11 standard for wireless LANs and all its amendments). In one embodiment, the functionality described herein can be implemented in a wireless network interface chip set, such as an 802.11 network interface chip set. Of course, the present invention can be used in connection with any suitable radio-frequency-based wireless network protocol. Switch 62 switches between upstream antenna 85 and downstream antenna 86 under the control of routing node control processor 70.

WLAN interface unit 80 comprises WLAN MAC control unit 82, WLAN radio module 84, and at least one antenna 87. Similar to backbone interface unit 60, WLAN radio module 84 includes frequency-based modulation/demodulation functionality for, in the receive direction, demodulating radio frequency signals and providing digital data streams to WLAN MAC control unit 82, and in the transmit direction, receiving digital data streams and providing frequency modulated signals corresponding to the digital data stream. In one embodiment, WLAN radio module 84 is an Orthogonal Frequency Division Multiplexed modulation/demodulation unit. In one embodiment, radio module 84 implements the OFDM functionality in a manner compliant with the IEEE 802.11a or the 802.11g protocol, and operates in either the 5 GHz or 2.4 GHz band, respectively. WLAN radio module 84 may also operate in a manner consistent with the 802.11b protocol employing DSSS data transmission schemes. Backbone MAC control unit 66 implements data link layer functionality, such as detecting individual frames in the digital data streams, error checking the frames, and the like. In one embodiment, backbone MAC control unit 66 implements the 802.11 wireless network protocol. Other suitable wireless protocols can be used in the present invention. In one embodiment, the functionality described herein can be implemented in a wireless network interface chip set, such as an 802.11 network interface chip set.

In one implementation, wireless backbone interface unit 60 and WLAN interface unit 80 operate in different frequency bands. For example, in one embodiment, backbone radio module 64 implements the OFDM encoding scheme in a manner compliant with the IEEE 802.11a protocol and, thus, operates in the 5 GHz band. WLAN radio module 84 may operate in the 2.4 GHz band in a manner consistent with either the 802.11b and/or 802.11g protocol. The use of different frequency bands for wireless backbone traffic and client traffic ensures that wireless client traffic does not disrupt operation of the wireless backbone implemented by the routing nodes. Of course, other schemes are possible, as the selection of frequency band for wireless backbone traffic and wireless traffic between clients and routing nodes is a matter of engineering choice. In other implementations, different non-overlapping channels within the same band can be used for wireless backbone traffic and client traffic.

FIG. 2 also illustrates the logical configuration of routing node control processor 70. Routing node control processor 70, as discussed above, controls the operation of wireless backbone interface unit 60 and WLAN interface unit 80. In one implementation, routing node control processor 70 is operative to control the operation of wireless backbone interface unit 60 to synchronize uplink and downlink transmission with other routing nodes in the mesh network. As discussed above, wireless backbone interface unit 60, in the receive direction, provides wireless frames received at upstream antenna 85 or downstream antenna 86. Flag detector 72, in one implementation, is operative to inspect the wireless frames received from other routing nodes, and determine whether the wireless frames should be forwarded along the wireless backbone or to a wireless client associated with the instant routing node via WLAN interface unit 80. In response to control signals transmitted by flag detector 72, logical switch 74 transmits the wireless packets along a WLAN path to WLAN interface unit 80, or a wireless backbone path to the upstream or downstream queues 77, 78. As FIG. 2 illustrates, routing node control processor 76 also includes logical switch 76 that switches between upstream transmit and receive queue 77 and downstream transmit and receive queue 78 depending on the current operational phase or mode (i.e., downstream phase or upstream phase). For example, wireless frames received from a parent routing node during the upstream phase are buffered in the downstream transmit/receive queue 78 for transmission to a child routing node during the downstream phase. Oppositely, wireless frames received from a child routing node during the downstream phase are buffered in upstream transmit/receive queue 77 for transmission to the parent routing node during the upstream phase. In the transmit direction, logical switch 76 switches between downstream and upstream queues depending on the transmission phase. For example, during the upstream transmission phase, logical switch 76 allows wireless frames stored on upstream transmit/receive queue 77 to be transmitted to the parent routing node via antenna 85. During the downstream transmission phase, logical switch 76 allows wireless frames stored in downstream transmit/receive queue 78 to be transmitted to a child routing node via antenna 86. In one implementation, both upstream and downstream queues 77, 78 may include separate queuing structures to achieve a variety of purposes. For example, routing node control processor 70 may be configured to include fast path and slow path queues for both the upstream and downstream queues 77, 78.

As discussed above, routing node control processor 70 is operative to switch between upstream and downstream antennas 85, 86 based on the current transmission phase (i.e., upstream or downstream phase). Upstream antenna 85 is used for data transfer with a parent routing node, while downstream antenna 86 is used for transfer with one or more child routing nodes. In one embodiment, upstream and downstream antennas 85, 86 are directional antennas whose peak gains are oriented depending on the location of the parent and child routing nodes. For example, in one implementation, upstream antenna 85 is generally oriented in the direction of the parent routing node. Downstream antenna 86 is oriented in the general direction of one or more child routing nodes. In one implementation, the peak gain and beamwidth of the downstream directional antennas will place an effective limit on the separation between the child routing nodes. Antennas 85, 85 can be any suitable directional antennas, such as patch antennas, yagi antennas, parabolic and dish antennas. In one embodiment, the peak gains of the antennas are offset from one another in a manner that maximizes coverage in all directions.

In another implementation, an omni-directional antenna can be used in place of upstream and downstream antennas 85, 86. In such an implementation, one operating channel is selected for downstream data transfer, while another non-overlapping channel is selected for upstream data transfer. Routing node control processor 70 switches between the upstream and downstream phases by controlling backbone radio module to switch between the downstream and upstream channels according to the synchronization mechanism discussed herein. Of course, a plurality of omni-directional antennas can also be used in connection with spatial antenna pattern diversity schemes to ameliorate multipath effects in indoor systems.

Root routing nodes 30 and leaf routing nodes 34 can include a subset of the functionality discussed above, since these routing nodes do not have either an upstream or downstream routing node. For example, both root and leaf routing nodes 30, 34 can each be configured to include a single directional, or omni-directional, antenna. Other functionality can also be omitted such as switch 62. In one implementation, however, each root or leaf routing node can include all the essential physical functionality discussed above, and be configured to operate in a root or leaf routing mode (as appropriate), where the downstream/upstream synchronization functionality is disabled. In that case, the leaf routing nodes 34, for example, operate in upstream mode the entire time. A configuration mechanism facilitates reconfiguration and extensions to the mesh network. For example, the wireless mesh network may be extended by simply adding additional routing nodes in the downstream direction of a leaf routing node and re-configuring the leaf routing node.

The invention has been explained with reference to specific embodiments. For example, although the embodiments described above operate in connection with 802.11 network protocols, the present invention can be used in connection with any suitable wireless network protocol. In addition, although the embodiment described above includes a single mesh network control system 20, other implementations of the present invention may incorporate the functionality of mesh network control system 20 into separate devices for each hierarchical tree. In addition, the functionality of mesh network control system 20 may be integrated into other network devices, such as root routing nodes 30. Other embodiments will be evident to those of ordinary skill in the art. It is therefore not intended that the invention be limited except as indicated by the appended claims.

1. In a wireless mesh environment comprising first, second and third wireless routing nodes, a method facilitating the transfer of data between wireless routing nodes, comprising
receiving a synchronization token from a first wireless routing node;
initiating a timer based on receipt of the synchronization token;
wirelessly communicating with the first wireless routing node, during a first time interval, to transmit or receive at least one wireless frame; and
upon expiration of the first time interval,
wirelessly communicating with the third wireless routing node, during a second time interval, to transmit or receive at least one wireless frame.

2. The method of claim 1 further comprising
transmitting a synchronization token to the third wireless routing node before the second communicating step.

3. The method of claim 1 further comprising
upon expiration of the second time interval, iteratively performing the first and second communicating steps upon expiration of the respective first and second time intervals.

4. The method of claim 2 further comprising
upon expiration of the second time interval, iteratively performing the first and second communicating steps upon expiration of the respective first and second time intervals.

5. The method of claim 2 further comprising
upon expiration of the second time interval, iteratively performing the receiving, initiating, and first and second communicating steps upon expiration of the respective first and second time intervals.

6. The method of claim 2 further comprising
upon expiration of the second time interval, iteratively performing the receiving, initiating, first and second communicating, and transmitting steps upon expiration of the respective first and second time intervals.

7. The method of claim 1 wherein the first and second time intervals are equal.

8. The method of claim 1 wherein wireless frames are 802.11 frames.

9. The method of claim 1 wherein the first wireless routing node is a parent routing node in a hierarchical mesh network.

10. The method of claim 9 wherein the third wireless routing node is a child routing node in a hierarchical mesh network.

11. The method of claim 1 wherein the first wireless routing node is a child routing node in a hierarchical mesh network.

12. The method of claim 11 wherein the third wireless routing node is a parent routing node in a hierarchical mesh network.

13. The method of claim 1 wherein at least one wireless frame transmitted to the first wireless routing node in the first communicating step was received from the third wireless routing node.

14. The method of claim 13 wherein at least one wireless frame transmitted to the third wireless routing node in the second communicating step was received from the first wireless routing node.

15. The method of claim 1 wherein at least one wireless frame transmitted to the third wireless routing node in the second communicating step was received from the first wireless routing node.

16. The method of claim 3 further comprising
wireless communicating with at least one wireless client device, concurrently with the first and second communicating steps; and
transmitting wireless frames received from the at least one wireless client device for transmission to the first wireless routing node during the third communicating step.

17. The method of claim 16 wherein at least one wireless frame received during the first or second communicating step is addressed to the at least one wireless client device; and wherein the method further comprises
transmitting the at least one wireless frame to the at least one wireless client device.

18. In a hierarchical wireless mesh environment comprising first, second and third wireless routing nodes, wherein the first wireless routing node is a parent of the second wireless routing node, and wherein the second wireless routing node is a parent of the third wireless routing node, a method facilitating the transfer of data between wireless routing nodes, comprising
receiving, at the second wireless routing node, a synchronization token from the first wireless routing node;
calibrating a timer based on receipt of the synchronization token;
wirelessly communicating with the first wireless routing node, during a first time interval, to transmit or receive at least one wireless frame; and
upon expiration of the first time interval,
wirelessly communicating with the third wireless routing node, during a second time interval, to transmit or receive at least one wireless frame.

19. The method of claim 18 further comprising
transmitting a synchronization token to the third wireless routing node during the second communicating step.

20. The method of claim 18 further comprising
upon expiration of the second time interval, iteratively performing the first and second communicating steps upon expiration of the respective first and second time intervals.

21. The method of claim 19 further comprising
upon expiration of the second time interval, iteratively performing the first and second communicating steps upon expiration of the respective first and second time intervals.

22. The method of claim 19 further comprising
upon expiration of the second time interval, iteratively performing the receiving, calibrating, and first and second communicating steps upon expiration of the respective first and second time intervals.

23. The method of claim 19 further comprising
upon expiration of the second time interval, iteratively performing the receiving, calibrating, first and second communicating, and transmitting steps upon expiration of the respective first and second time intervals.

24. The method of claim 18 wherein the first and second time intervals are equal.

25. The method of claim 18 wherein wireless frames are 802.11 frames.

26. The method of claim 18 wherein the first wireless routing node is a parent routing node in a hierarchical mesh network.

27. The method of claim 26 wherein the third wireless routing node is a child routing node in a hierarchical mesh network.

28. A method facilitating the transfer of data between wireless routing nodes, comprising
receiving a synchronization token;
calibrating a timer based on receipt of the synchronization token; and
cycling, based on the timer, between an upstream transmission phase and a downstream transmission phase;
wherein the upstream transmission phase comprises
receiving wireless frames from a parent wireless routing node;
storing at least one received wireless frames in a downstream buffer;
transmitting at least one wireless frame stored in an upstream buffer to the parent wireless routing node;
wherein the downstream transmission phase comprises
receiving wireless frames from at least one child wireless routing node;
storing at least one received wireless frame in the upstream buffer;
transmitting at least one wireless frame stored in the downstream buffer to the at least one child routing node.

29. The method of claim 28 further comprising transmitting a synchronization token to the at least one child node at the start of the first iteration of the downstream transmission phase.

30. The method of claim 28 wherein the synchronization token is received from the parent wireless routing node.

31. The method of claim 29 wherein the synchronization token is received from the parent wireless routing node.

32. The method of claim 28 wherein the synchronization token is received from at least one child wireless routing node.

33. The method of claim 28 wherein the downstream buffer is a queue structure.

34. The method of claim 28 wherein the upstream buffer is a queue structure.

35. The method of claim 28 wherein the downstream phase further comprises transmitting a synchronization token to the at least one child node at the start of the downstream transmission phase; and
wherein the upstream phase comprises
before performing the receiving, storing and transmitting steps, listening for a synchronization packet; and
upon receipt of a synchronization token from the parent wireless routing node, resetting the timer.

36. The method of claim 28 further comprising
receiving subsequent synchronization packets from the parent wireless routing node; and
updating the timer based on receipt of the subsequent synchronization packets.

37. The method of claim 28 wherein the calibrating step comprises initiating the timer based on receipt of the synchronization token.

38. An apparatus for use in a wireless network, comprising
a wireless interface operative to wirelessly communicate with an upstream routing node and at least one downstream routing node.
a routing node control processor, operably connected to the wireless interface, and comprising a duty cycle timer; wherein the routing node control processor is operative to
calibrate the duty cycle timer based on receipt, at the wireless interface, of a synchronization token from an upstream routing node; and
cycle, based on the duty cycle timer, between an upstream transmission phase and a downstream transmission phase; wherein, in the upstream transmission phase, the routing node control processor is operative to
store at least one wireless frame received from the upstream routing node in a downstream buffer; and
transmit from the wireless interface at least one wireless frame stored in an upstream buffer to the upstream routing node; and
wherein, in the downstream transmission phase, the routing node control processor is operative to
store at least one wireless frame received from the downstream routing node in a upstream buffer; and
transmit from the wireless interface at least one wireless frame stored in a downstream buffer to the downstream routing node.

39. The apparatus of claim 38 wherein the wireless interface comprises at least one antenna.

40. The apparatus of claim 38 wherein the wireless interface comprises an upstream antenna and a downstream antenna.

41. A method facilitating the transfer of data between wireless routing nodes, comprising
receiving a synchronization token;
calibrating a timer based on receipt of the synchronization token; and
cycling, based on the timer, between an upstream transmission phase and a downstream transmission phase;
wherein the upstream transmission phase comprises
receiving wireless frames from a parent wireless routing node;
storing at least one received wireless frames in a downstream buffer;
transmitting at least one wireless frame stored in an upstream buffer to the parent wireless routing node;
receiving a synchronization token and re-calibrating the time based on receipt of the synchronization token;
wherein the downstream transmission phase comprises
receiving wireless frames from at least one child wireless routing node;
storing at least one received wireless frame in the upstream buffer;
transmitting at least one wireless frame stored in the downstream buffer to the at least one child routing node.

42. The method of claim 41 wherein the downstream transmission phase further comprises
transmitting a synchronization token to at least one child routing node at the midpoint of the downstream transmission phase.

43. The method of claim 41 wherein the synchronization token is received from the parent wireless routing node.

44. The method of claim 42 wherein the synchronization token is received from the parent wireless routing node.

45. The method of claim 41 wherein the downstream buffer is a queue structure.

46. The method of claim 41 wherein the upstream buffer is a queue structure.
